(19) United States
(12) Patent Application Publication
(10) Pub. No.: US 2025/0280984 A1
(43) Pub. Date: Sep. 11, 2025

(54) INFORMATION PROCESSING APPARATUS, INFORMATION PROCESSING SYSTEM, AND INFORMATION PROCESSING METHOD

(71) Applicant: Yutaka Nakamura, KANAGAWA (JP)

(72) Inventor: Yutaka Nakamura, KANAGAWA (JP)

(73) Assignee: Ricoh Company, Ltd., Tokyo (JP)

(21) Appl. No.: 19/051,598

(22) Filed: Feb. 12, 2025

(30) Foreign Application Priority Data
Mar. 8, 2024 (JP) 2024-036045
Nov. 15, 2024 (JP) 2024-200003

(51) Int. Cl. A47G 29/14; H04W 4/029

(52) U.S. Cl. CPC A47G 29/141; H04W 4/029

(57) ABSTRACT

An information processing apparatus, comprising circuitry to: manage location information indicating a current location of a user who goes to a specific place where a locker is present repeatedly; acquire information of the user who is a recipient of a parcel stored in the locker from a locker management system that manages a usage status of the locker; acquire the location information of the user who is the recipient; and issue a notification that prompts the user who is the recipient to go to the specific place when the location information indicates that the user who is the recipient is not at the specific place.

### CROSS-REFERENCE TO RELATED APPLICATIONS

This patent application is based on and claims priority pursuant to 35 U.S.C. § 119(a) to Japanese Patent Application Nos. 2024-036045, filed on Mar. 8, 2024, and 2024-200003, filed on Nov. 15, 2024, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

With smart locker technology, the number of times a locker is opened and closed, the usage status of the locker, and users of the locker used for non-face-to-face delivery of luggage are remotely managed. Such a locker is sometimes referred to as a “parcel locker.” For example, providers of an electronic commerce (EC) site who work with, for example, convenience stores or parcel locker companies use the smart locker technology to support reception of products at various reception facilities.

### SUMMARY

According to one aspect of the present disclosure, an information processing apparatus includes circuitry to: manage location information indicating a current location of a user who goes to a specific place where a locker is present repeatedly; acquire information of the user who is a recipient of a parcel stored in the locker from a locker management system that manages a usage status of the locker; acquire the location information of the user who is the recipient; and issue a notification that prompts the user who is the recipient to go to the specific place when the location information indicates that the user who is the recipient is not at the specific place.

According to one aspect of the present disclosure, an information processing system includes a user terminal and an information processing apparatus communicably connected to the user terminal. The information processing apparatus including first circuitry to: manage location information indicating a current location of a user who goes to a specific place where a locker is present repeatedly; acquire information of the user who is a recipient of a parcel stored in the locker from a locker management system that manages a usage status of the locker; acquire the location information of the user who is the recipient; and issue a notification that prompts the user who is the recipient to go to the specific place when the location information indicates that the user who is the recipient is not at the specific place. The user terminal includes second circuitry to: receive the notification from the information processing apparatus; and display the notification.

According to one aspect of the present disclosure, an information processing method performed by an information processing apparatus includes: managing location information indicating a current location of a user who goes to a specific place where a locker is present repeatedly; acquiring information of the user who is a recipient of a parcel stored in the locker from a locker management system that manages a usage status of the locker; acquiring the location information of the user who is the recipient; and issuing a notification that prompts the user who is the recipient to go to the specific place when the location information indicates that the user who is the recipient is not at the specific place.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of an information processing system;

FIG. 2 is a block diagram illustrating an example of a hardware configuration of a smartphone;

FIG. 3 is a block diagram illustrating an example of a hardware configuration of a computer;

FIG. 4 is a block diagram illustrating an example of a functional configuration of the information processing system of FIG. 1;

FIG. 5 is a diagram illustrating an example of a data structure of work status information stored in a work status storage unit;

FIG. 6 is a diagram illustrating an example of a data structure of resource information stored in a resource storage unit;

FIG. 7 is a diagram illustrating an example of a data structure of floor layout information stored in a floor layout storage unit;

FIG. 8 is a diagram illustrating an example of a data structure of seat usage information stored in a seat usage storage unit;

FIG. 9 is a diagram illustrating an example of a data structure of member setting information stored in a member setting storage unit;

FIG. 10 is a diagram illustrating an example of a data structure of information of a locker cooperation notification setting stored in a locker cooperation notification setting storage unit;

FIG. 11 is a diagram illustrating an example of a data structure of locker usage information stored in a locker usage storage unit;

FIG. 12 is a view illustrating an example of an administrator setting screen;

FIG. 13 is a view illustrating an example of a user screen;

FIG. 14 is a sequence diagram of an example of an operation performed by the information processing system of FIG. 1 when the usage rate of a parcel locker exceeds a work attendance reminder notification threshold value;

FIG. 15 is a sequence diagram illustrating an example of an operation performed by the information processing system of FIG. 1 when a user updates a work status to working at the office;

FIG. 16 is a sequence diagram of an example of an operation performed by the information processing system of FIG. 1 when the usage rate of a parcel locker exceeds a proxy pickup request notification threshold value;

FIG. 17 is a sequence diagram illustrating an example of an operation performed by the information processing system of FIG. 1 when a user uses a seat recommendation function;

FIG. 18 is a block diagram illustrating another example of a functional configuration of the information processing system of FIG. 1;

FIG. 19 is a sequence diagram of another example of an operation performed by the information processing system of FIG. 1 when the usage rate of a parcel locker exceeds a work attendance reminder notification threshold value;

FIG. 20 is a sequence diagram illustrating an example of an operation performed by the information processing system of FIG. 1 when a user updates an attendance status to being present;

FIG. 21 is a sequence diagram of another example of an operation performed by the information processing system of FIG. 1 when the usage rate of a parcel locker exceeds a proxy pickup request notification threshold value; and

FIG. 22 is a block diagram illustrating still another example of a functional configuration of the information processing system of FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings.

### First Embodiment

### System Configuration

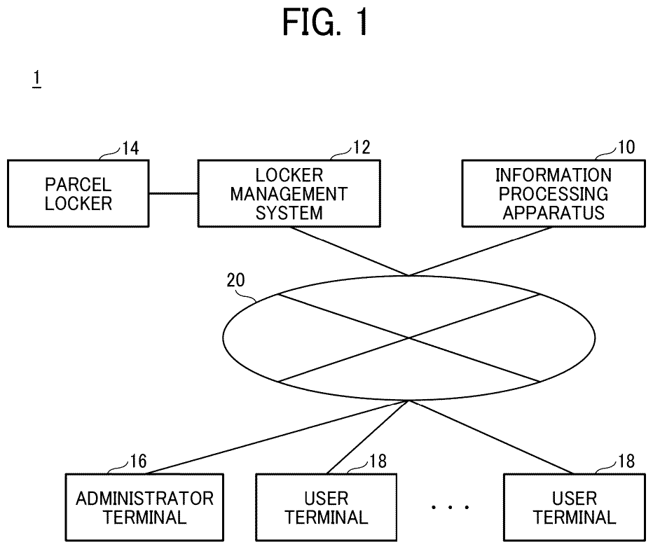

FIG. 1 is a schematic view illustrating an example of a configuration of an information processing system 1 according to the present embodiment. The information processing system 1 illustrated in FIG. 1 is used by an organization such as a company that introduces hybrid work, which is a work style that combines working in an office or the like and the working from home or the like. The information processing system 1 illustrated in FIG. 1 includes an information processing apparatus 10, a locker management system 12, a parcel locker 14, an administrator terminal 16, and a plurality of user terminals 18, which are communicably connected to each other through a network 20. The network 20 is, for example, the Internet or a local area network (LAN).

The administrator terminal 16 is a communication terminal used by an administrator of an organization. The administrator terminal 16 is, for example, a personal computer (PC), a smartphone, a tablet terminal, or a mobile phone.

The user terminal 18 is a communication terminal used by a user (e.g., an employee) who works in an organization that has introduced hybrid work. A user who uses the user terminal 18 works in a combination of office work, where the user goes to an office or the like to work, and telecommuting, where the user works from home or the like. The user who uses the user terminal 18 is an example of a user who is in a work status, either at work or a status other than at work. The user terminal 18 is, for example, a PC, a smartphone, a tablet terminal, or a mobile phone.

The parcel locker 14 is a locker for non-face-to-face delivery of parcels. The parcel locker 14 is used by a user who works in a hybrid work environment and uses the user terminal 18. For example, the parcel locker 14 is used when a parcel such as supplies or documents is exchanged between a sender or a delivery company and a user (recipient) who uses the user terminal 18. The locker is not limited to the parcel locker, but may be locker for non-face-to-face delivery of a parcel, such as a delivery box or a smart locker for receiving a product purchased online.

The locker management system 12 communicates with the parcel locker 14, and manages the usage status of the locker, such as the storage status of a parcel in the locker and information on a user who is a recipient of the parcel stored in the locker. The locker management system 12 is, for example, a PC or a workstation.

The information processing apparatus 10 manages the work status of a user who uses the user terminal 18. The information processing apparatus 10 further manages layout information of resources including seats and a parcel locker 14 located in an office or the like, which is an example of a place where a user who uses the user terminal 18 goes to work. Further, the information processing apparatus 10 receives information on a seat used by a user working at the office or a reservation for a seat to be used in the office or the like by a user who is going to work at the office.

The information processing apparatus 10 communicates with the locker management system 12 to exchange needed information with each other. The information processing apparatus 10 and the locker management system 12 cooperate with each other via, for example, an application programming interface (API).

The information processing apparatus 10 acquires information on a user who is a recipient of a parcel stored in the parcel locker 14 from the locker management system 12, and performs processing described later according to a work status of the user who is the recipient. This prevents the time period during which the parcel is stored in the parcel locker 14 from getting longer and increases the turnover rate of the parcel locker 14. The information processing apparatus 10 is, for example, a PC or a workstation. The information processing apparatus 10 may be implemented by, for example, a work status/seat management system.

The information processing apparatus 10 may be, for example, a printer, a scanner, a facsimile, a multifunction peripheral, a projector, a display device having an electronic whiteboard function, an output device such as a digital signage, a head-up display device, an industrial machine, an imaging device, a sound collecting device, a medical device, a networked home appliance, a connected car, or a game console.

The configuration of the information processing system 1 illustrated in FIG. 1 is just an example. The configuration of the information processing system 1 varies depending on the application and purpose. For example, the information processing apparatus 10 and the locker management system 12 may be implemented by one or more computers.

The information processing apparatus 10 and the locker management system 12 may be implemented as a cloud computing service. The information processing apparatus 10 and the locker management system 12 may be integrated.

### Hardware Configuration

### Hardware Configuration of Smartphone

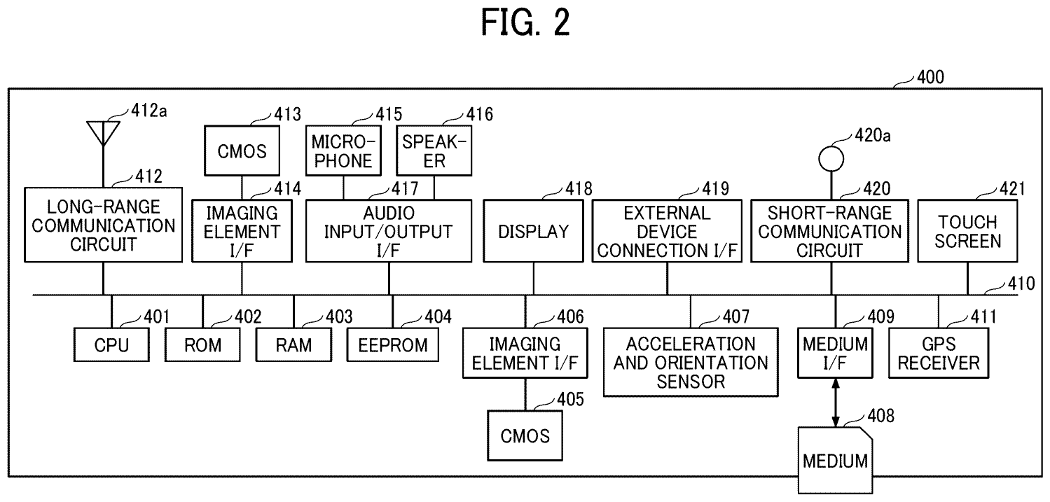

The administrator terminal 16 and the user terminal 18 may be implemented by a smartphone 400 having a hardware configuration as illustrated in FIG. 2. FIG. 2 is a block diagram illustrating an example of the hardware configuration of the smartphone 400.

The smartphone 400 includes a central processing unit (CPU) 401, a read-only memory (ROM) 402, a random-access memory (RAM) 403, an electrically erasable programmable read-only memory (EEPROM) 404, a complementary metal oxide semiconductor (CMOS) sensor 405, an imaging element interface (I/F) 406, an acceleration and orientation sensor 407, a medium I/F 409, and a global positioning system (GPS) receiver 411.

The CPU 401 controls overall operation of the smartphone 400. The ROM 402 stores a program such as an initial program loader (IPL) to boot the CPU 401. The RAM 403 is used as a work area for the CPU 401. The EEPROM 404 reads or writes various data such as a control program for the smartphone under control of the CPU 401.

The CMOS sensor 405 is an example of a built-in imaging device that captures an object (mainly, a self-image of a user) under control of the CPU 401 and obtains image data. In alternative to the CMOS sensor, an imaging element such as a charge-coupled device (CCD) sensor may be used. The imaging element I/F 406 is a circuit that controls driving of the CMOS sensor 405. The acceleration and orientation sensor 407 includes various sensors such as an electromagnetic compass for detecting geomagnetism, a gyrocompass, and an acceleration sensor. The medium I/F 409 controls reading or writing (storage) of data to a storage medium 408 such as a flash memory. The GPS receiver 411 receives a GPS signal from a GPS satellite.

The smartphone 400 further includes a long-range communication circuit 412, an antenna 412a for the long-range communication circuit 412, a CMOS sensor 413, an imaging element I/F 414, a microphone 415, a speaker 416, an audio input/output I/F 417, a display 418, an external device connection I/F 419, a short-range communication circuit 420, an antenna 420a for the short-range communication circuit 420, and a touch screen 421. The long-range communication circuit 412 is a circuit that allows the smartphone 400 to communicate with other devices through the network 20. The CMOS sensor 413 is an example of a built-in imaging device that captures an image of an object to obtain image data under control of the CPU 401. The imaging element I/F 414 is a circuit that controls driving of the CMOS sensor 413. The microphone 415 is a built-in circuit that converts audio into electrical signals. The speaker 416 is a built-in circuit that converts electrical signals into physical vibrations to generate audio such as music or voice.

The audio input/output I/F 417 is a circuit for inputting and outputting an audio signal between the microphone 415 and the speaker 416 under control of the CPU 401. The display 418 is an example of display means that displays an image of the object and various icons. Examples of the display 418 include a liquid crystal display (LCD) and an organic electroluminescence (EL) display.

The external device connection I/F 419 is an interface for connecting the smartphone 400 to various external devices. The short-range communication circuit 420 is a communication circuit that communicates in compliance with, for example, the near field communication (NFC) or the Bluetooth®. The touch screen 421 is an example of input means that enables a user to operate the smartphone 400 by touching a screen of the display 418. The smartphone 400 further includes a bus line 410. The bus line 410 is, for example, an address bus or a data bus that electrically connects the elements illustrated in FIG. 2, such as the CPU 401, with one another.

### Hardware Configuration of Computer

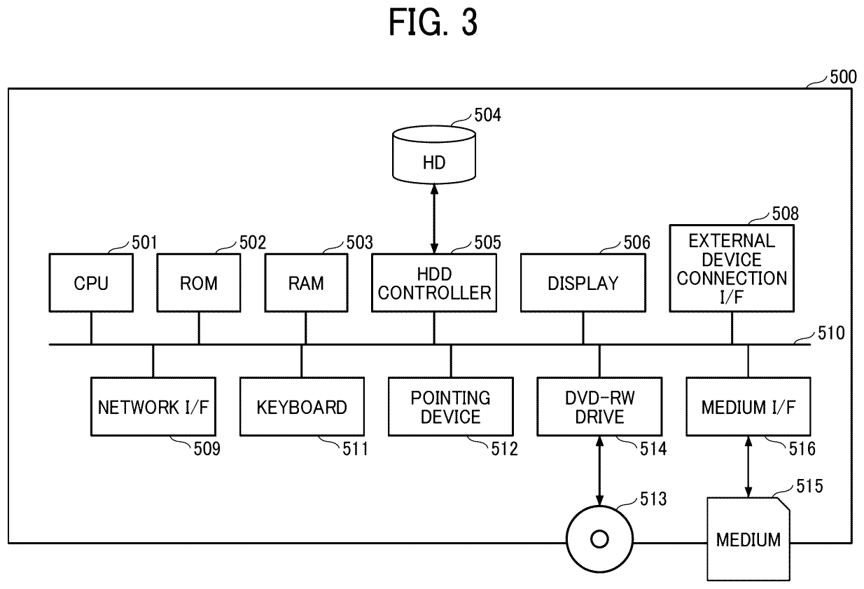

Each of the information processing apparatus 10 and the locker management system 12 illustrated in FIG. 1 may be implemented by a computer 500 having a hardware configuration as illustrated in FIG. 3. Further, each of the administrator terminal 16 and the user terminal 18 may be implemented by the computer 500 having a hardware configuration as illustrated in FIG. 3. FIG. 3 is a block diagram illustrating an example of the hardware configuration of the computer 500.

The computer 500 includes a CPU 501, a ROM 502, a RAM 503, a hard disk (HD) 504, a hard disk drive (HDD) controller 505, a display 506, an external device connection I/F 508, a network I/F 509, a data bus 510, a keyboard 511, a pointing device 512, a digital versatile disc-rewritable (DVD-RW) drive 514, and a medium I/F 516.

The CPU 501 controls overall operation of the computer 500 according to a program. The ROM 502 stores programs such as an IPL to boot the CPU 501. The RAM 503 is used as a work area for the CPU 501. The HD 504 stores various kinds of data such as a program. The HDD controller 505 controls the reading and writing of various data from and to the HD 504 under control of the CPU 501.

The display 506 displays various information such as a cursor, menu, window, character, or image. The external device connection I/F 508 is an interface for connecting the computer 500 to various external devices. Examples of the external devices include, but are not limited to, a universal serial bus (USB) memory. The network I/F 509 is an interface for performing data communication using the network 20. The data bus 510 is, for example, an address bus or a data bus that electrically connects the elements such as the CPU 501 with one another.

The keyboard 511 is an example of input means including multiple keys that allow a user to input characters, numerals, or various instructions. The pointing device 512 is an example of input means that allows a user to select or execute a specific instruction, select a target for processing, or move a cursor being displayed. The DVD-RW drive 514 controls reading or writing of various data from or to a DVD-RW 513, which is an example of a removable recording medium. The DVD-RW is merely one example of the removable recording medium. In another example, a digital versatile disc recordable (DVD-R) may be used as the removable recording medium. The medium I/F 516 controls reading and writing (storing) of data from and to a recording medium 515 such as a flash memory.

The hardware configuration illustrated in FIG. 3 is just one example, and the hardware configuration may not include all of the hardware components illustrated in FIG. 3, or may include any other hardware components than the ones illustrated in FIG. 3.

### Functional Configuration

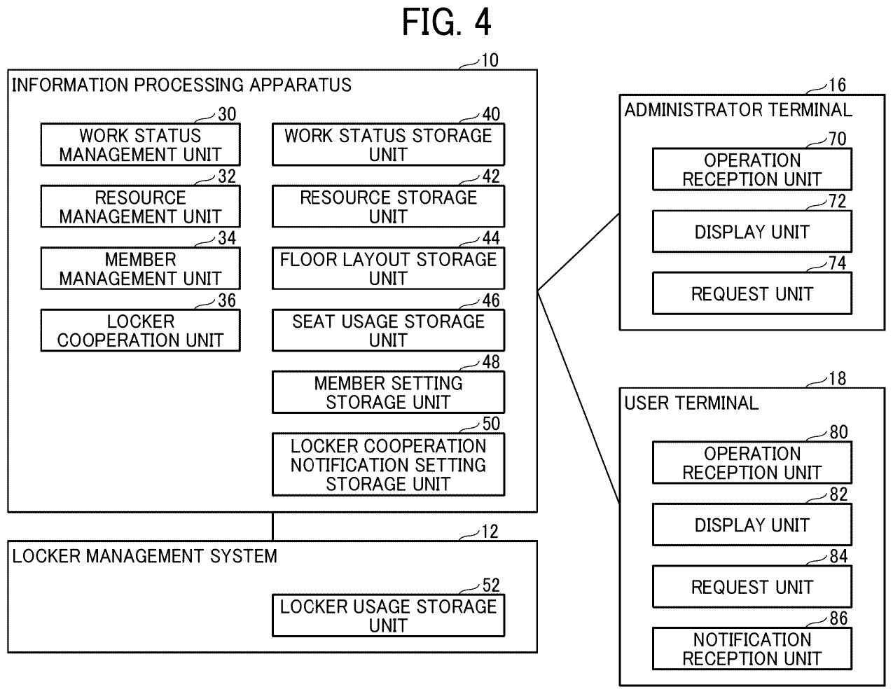

FIG. 4 is a block diagram illustrating an example of the functional configuration of the information processing system 1 according to the present embodiment. In the description of the functional configuration illustrated in FIG. 4, descriptions of components unnecessary for the description of the present embodiment may be omitted. The information processing apparatus 10, the locker management system 12, the administrator terminal 16, and the user terminal 18 illustrated in FIG. 4 implement the functional configuration illustrated in FIG. 4 by, for example, the smartphone 400 illustrated in FIG. 2 or the computer 500 illustrated in FIG. 3 executing an operating system (OS) and a program.

The information processing apparatus 10 illustrated in FIG. 4 includes a work status management unit 30, a resource management unit 32, a member management unit 34, a locker cooperation unit 36, a work status storage unit 40, a resource storage unit 42, a floor layout storage unit 44, a seat usage storage unit 46, a member setting storage unit 48, and a locker cooperation notification setting storage unit 50. The locker management system 12 includes a locker usage storage unit 52. The administrator terminal 16 includes an operation reception unit 70, a display unit 72, and a request unit 74. The user terminal 18 includes an operation reception unit 80, a display unit 82, a request unit 84, and a notification reception unit 86.

The work status management unit 30 of the information processing apparatus 10 manages the work status of a user working for, for example, a company.

The work status of the user includes, for example, working at the office, working from home, going out, and having finished working. The working from home, the going out, and the having finished working are examples of the work status of the user other than the working at the office. When the work status of the user changes, the work status management unit 30 notifies the locker cooperation unit 36 of the work status change. The work status management unit 30 sends the work status of the user in response to a request from the locker cooperation unit 36.

The resource management unit 32 manages layout information of resources including seats and the parcel locker 14 located in a place where the user works (e.g., an office). The resource management unit 32 manages the usage status of the seat of a user who works in an office or the like. The resource management unit 32 receives and manages a reservation for a seat from a user who works in an office or the like.

When the resource management unit 32 receives a reservation for a seat from a user who works in an office or the like, the resource management unit 32 checks with the locker cooperation unit 36 whether a parcel of which the recipient is the user is stored. When a parcel of which the recipient is the user from who the reservation for a seat is received is stored in the parcel locker 14, the resource management unit 32 preferentially selects a seat near the parcel locker 14 in which the parcel is stored, and sends a notification indicating the recommendation for the seat to the user. Further, the resource management unit 32 issues a notification prompting the pickup of the parcel stored in the parcel locker 14. This prevents the time period during which a parcel of which the recipient is a user other than a user who is working in the office among parcels stored in the parcel locker 14 from getting longer and increases the turnover rate of the parcel locker 14.

The member management unit 34 manages members who pick up a parcel from the parcel locker 14 on behalf of the user as a recipient of the parcel. The member management unit 34 manages the settings of members registered for respective users. The member management unit 34 sends the settings of members registered for respective users in response to a request from the locker cooperation unit 36.

The locker cooperation unit 36 cooperates with the locker management system 12 that manages the usage status of the parcel locker 14, and checks whether a parcel of which recipient is the user is stored in the parcel locker 14. When the parcel locker 14 stores a parcel of which the recipient is the user, the locker cooperation unit 36 performs notification as described later. This prevents the time period during which a parcel of which the recipient is a user other than a user who is working in the office among parcels stored in the parcel locker 14 from getting longer and increases the turnover rate of the parcel locker 14.

The locker cooperation unit 36 receives a check as to whether a parcel of which the recipient is the user is stored from the resource management unit 32. When a parcel of which the recipient is the user is stored in the parcel locker 14, the locker cooperation unit 36 send a reply indicating that the parcel is stored.

The locker cooperation unit 36 acquires the work status of the user who is the recipient of a parcel stored in the parcel locker 14 from the work status management unit 30. The locker cooperation unit 36 acquires, from the member management unit 34, the settings of members who receive a parcel from the parcel locker 14 on behalf of the user.

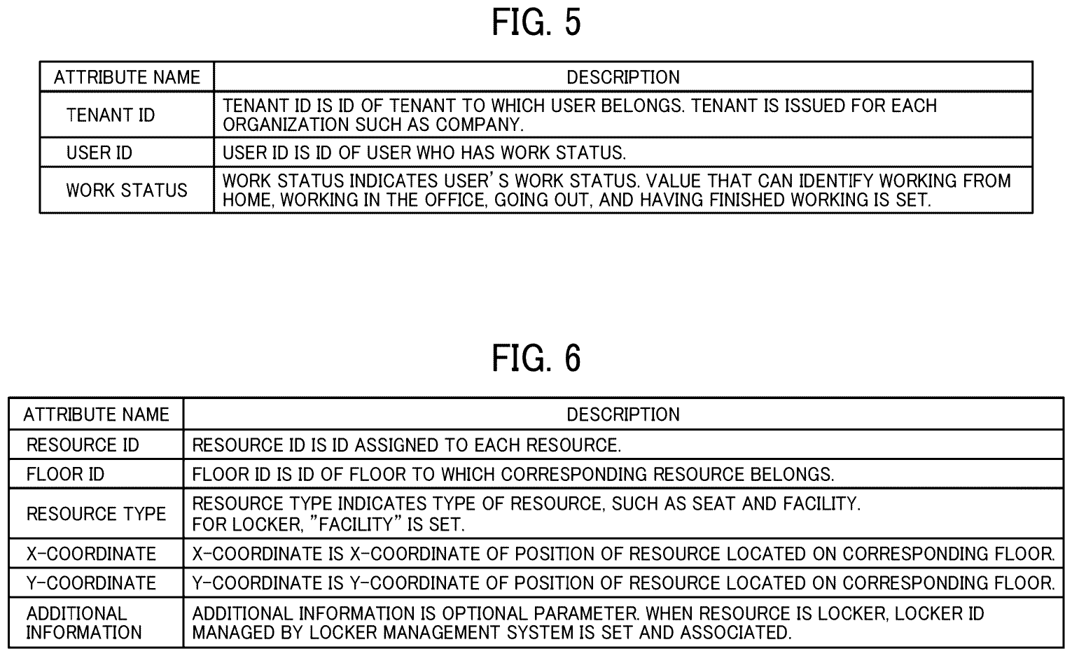

The work status storage unit 40 stores work status information as illustrated in FIG. 5. FIG. 5 is a diagram illustrating an example of a data structure of the work status information stored in the work status storage unit 40. The work status information as illustrated in FIG. 5 is managed by the work status management unit 30.

The work status information includes a tenant identifier (ID), a user ID, and a work status as attributes. The tenant ID is an ID (identification information) of a tenant to which a user belongs. The tenant is issued for each organization where the user works, such as a company. The user ID is an ID of the user who has a work status. The work status is a work status of the user. A value that can identify working from home, working in the office, going out, and having finished working is set.

The resource storage unit 42 stores resource information as illustrated in FIG. 6. FIG. 6 is a diagram illustrating an example of a data structure of the resource information stored in the resource storage unit 42. The resource information illustrated in FIG. 6 is managed by the resource management unit 32.

The resource information includes a resource ID, a floor ID, a resource type, an x-coordinate, a y-coordinate, and additional information as attributes. The resource ID is an ID assigned to each resource. The floor ID is an ID of a floor to which the corresponding resource belongs.

The resource type is a type of the resource, such as a seat and a facility. The x-coordinate is an x-coordinate of the position of the resource located on the corresponding floor. The y-coordinate is a y-coordinate of the position of the resource located on the corresponding floor. The additional information is an optional parameter. When the resource is the parcel locker 14, the resource information illustrated in FIG. 6 is associated with the parcel locker 14 by setting a locker ID managed by the locker management system 12 in the additional information.

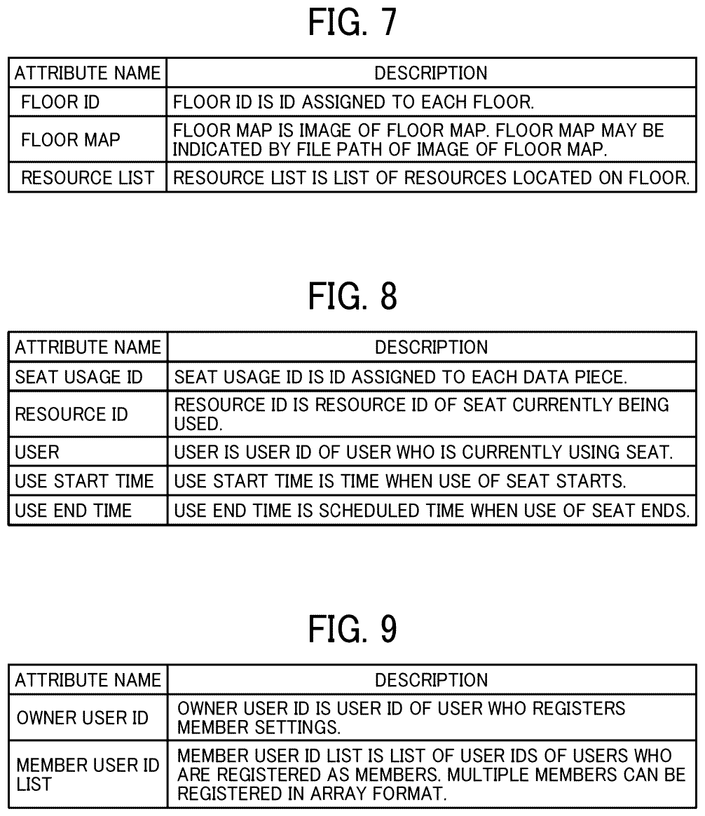

The floor layout storage unit 44 stores floor layout information as illustrated in FIG. 7. FIG. 7 is a diagram illustrating an example of a data structure of the floor layout information stored in the floor layout storage unit 44. The floor layout information as illustrated in FIG. 7 is managed by the resource management unit 32.

The floor layout information includes a floor ID, a floor map, and a resource list as attributes. The floor ID is an ID assigned to each floor. The floor map is an image of a floor map. The floor map may be indicated by a file path of the image of the floor map. The resource list is a list of resources located on the floor.

The seat usage storage unit 46 stores seat usage information as illustrated in FIG. 8. FIG. 8 is a diagram illustrating an example of a data structure of the seat usage information stored in the seat usage storage unit 46. The seat usage information as illustrated in FIG. 8 is managed by the resource management unit 32.

The seat usage status information includes a seat usage ID, a resource ID, a user, a use start time, and a use end time as attributes. The seat usage ID is an ID assigned to each data piece of the seat usage information. The resource ID is a resource ID of a seat being used. The user is a user ID of a user who is currently using the seat. The use start time is a time when the use of the seat starts. The use end time is a scheduled time when the use of the seat ends.

The member setting storage unit 48 stores member setting information as illustrated in FIG. 9. FIG. 9 is a diagram illustrating an example of a data structure of the member setting information stored in the member setting storage unit 48. The member setting information as illustrated in FIG. 9 is managed by the member management unit 34.

The member setting information includes an owner user ID and a member user ID list as attributes. The owner user ID is a user ID of a user who registers member settings. The member user ID list is a list of user IDs of users who are registered as members. In the member user ID list, multiple members can be registered, for example, in an array format.

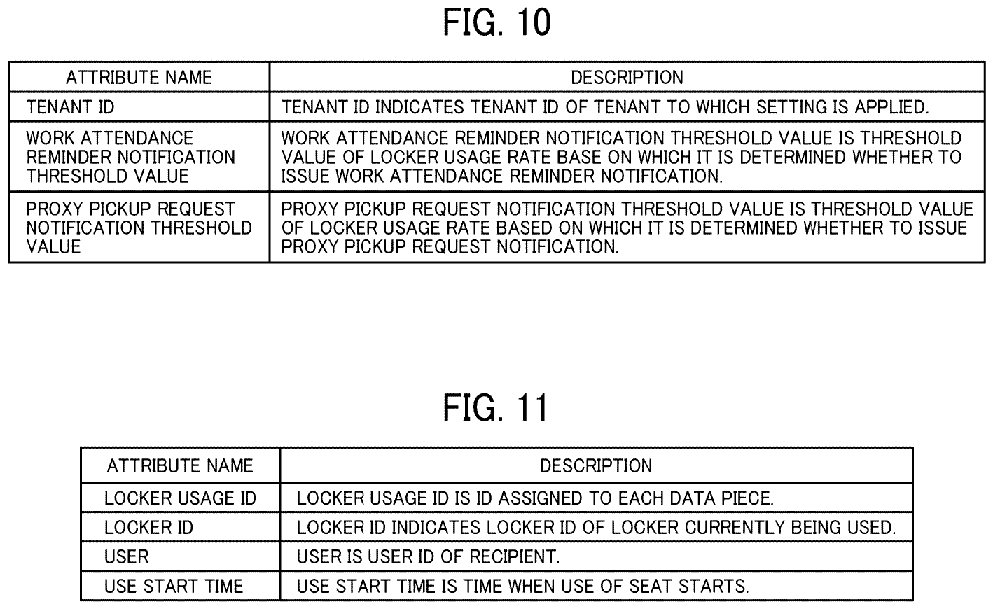

The locker cooperation notification setting storage unit 50 stores information of a locker cooperation notification setting as illustrated in FIG. 10. FIG. 10 is a diagram illustrating an example of a data structure of the information of the locker cooperation notification setting stored in the locker cooperation notification setting storage unit 50. The information of the locker cooperation notification setting as illustrated in FIG. 10 is managed by the locker cooperation unit 36.

The information of the locker cooperation notification setting includes a tenant ID, a work attendance reminder notification threshold value, and a proxy pickup request notification threshold value as attributes. The tenant ID is a tenant ID of a tenant to which the locker cooperation notification setting is applied. The work attendance reminder notification threshold value is a threshold value of the locker usage rate for determining whether to issue a reminder to come to the workplace such as the office. In the disclosure, such a reminder may be referred to as a “work attendance reminder notification.” The proxy pickup request notification threshold value is a threshold of value the locker usage rate for determining whether to issue a proxy pickup request notification.

The locker usage storage unit 52 of the locker management system 12 stores locker usage information as illustrated in FIG. 11. FIG. 11 is a diagram illustrating an example of a data structure of the locker usage information stored in the locker usage storage unit 52. The locker usage information as illustrated in FIG. 11 is managed by the locker management system 12.

The locker usage information includes a locker use ID, a locker ID, a user, and a use start time as attributes. The locker usage ID is an ID assigned to each data piece of the locker usage information. The locker ID is a locker ID of the parcel locker 14 currently being used (i.e., in which a parcel of which the recipient is the user is stored). The user is a user ID of the recipient. The use start time is a start time of use of the parcel locker 14 (i.e., a time when the storage of the parcel of the recipient is the user starts).

The operation reception unit 70 of the administrator terminal 16 receives various operations from an administrator, such as the setting of thresholds for various notifications described later. The display unit 72 displays a user interface (UI) for the administrator. The request unit 74 makes various requests to the information processing apparatus 10, such as a request to set thresholds for various notifications described later.

The operation reception unit 80 of the user terminal 18 receives various operations from a user in any of work statuses or a member who pick up a parcel from the parcel locker 14 on behalf of the user.

The display unit 82 displays a UI for the user or the member and displays a notification described later received by the notification reception unit 86 from the information processing apparatus 10. The request unit 84 makes various requests to the information processing apparatus 10. The notification reception unit 86 receives a notification as described later from the information processing apparatus 10.

### UI Example

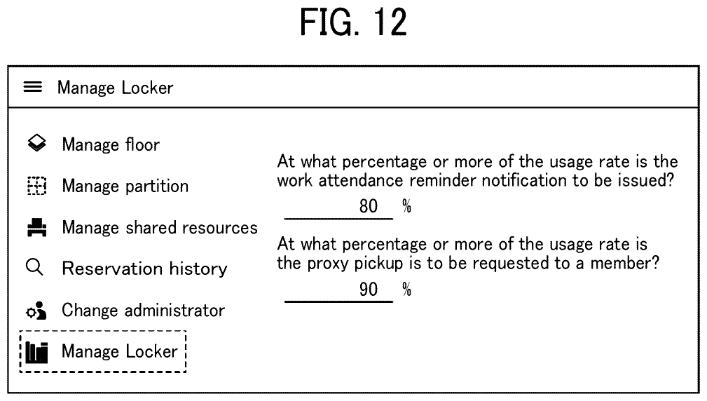

FIG. 12 is a view illustrating an example of an administrator setting screen. The administrator setting screen of FIG. 12 is displayed on the administrator terminal 16. An administrator who uses the administrator terminal 16 sets the work attendance reminder notification threshold value and the proxy pickup request notification threshold value included in the information of the locker cooperation notification setting of FIG. 10, for example, via the administrator setting screen illustrated in FIG. 12. In the administrator setting screen of FIG. 12, “80%” is set as the threshold value of the locker usage rate for determining whether the work attendance reminder notification is to be issued, and “90%” is set as the threshold value of the locker usage rate for determining whether the proxy pickup request notification is to be issued.

According to the settings of the work attendance reminder notification threshold value and the proxy pickup request notification threshold value configured by the administrator on the administrator setting screen as illustrated in FIG. 12, the information processing system 1 according to the present embodiment issues the work attendance reminder notification when the locker usage rate reaches 80%, and issues the proxy pickup request notification when the locker usage rate reaches 90%.

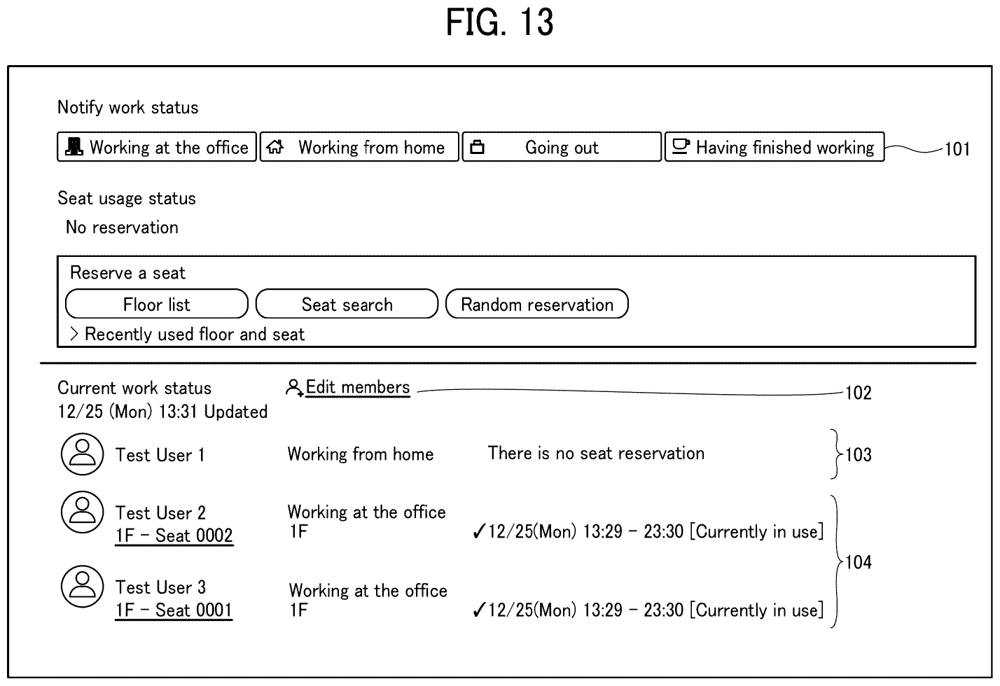

FIG. 13 is a view illustrating an example of a user screen. The user screen of FIG. 13 is displayed on the user terminal 18. The user who uses the user terminal 18 performs operations described below via the user screen as illustrated in FIG. 13. The user screen of FIG. 13 is displayed when the user operates the user terminal 18 to log in to the information processing apparatus 10.

The user screen of FIG. 13 displays a work status notification field 101, a member edit link 102, a user work status field 103, and a member work status display field 104. The user who uses the user terminal 18 updates his/her own work status included in the work status information of FIG. 5 by operating (e.g., clicking) the buttons of “working at the office,” “working from home,” “going out,” and “having finished working” in the work status notification field 101 in the user screen of FIG. 13.

The user who uses the user terminal 18 registers or deregisters members to be displayed in the member work status display field 104 from the member edit link 102. The user work status field 103 displays the current work status and seat usage status of the user who has logged in. The member work status display field 104 displays the current work status and seat usage status of the members registered from the member edit link 102.

### Operation

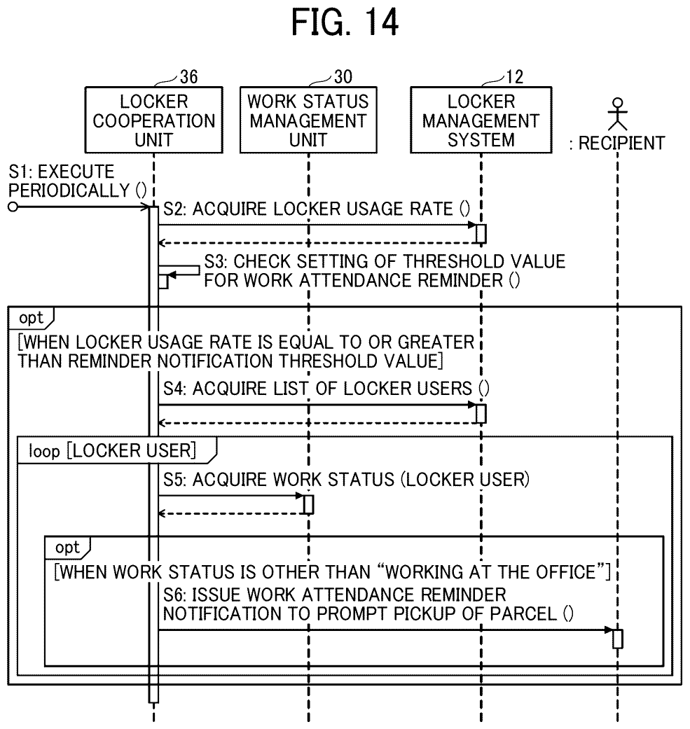

When the usage rate of the parcel locker 14 exceeds the work attendance reminder notification threshold value, the information processing system 1 according to the present embodiment performs an operation illustrated in the sequence diagram of FIG. 14. Thus, the usage rate of the parcel locker 14 increases.

FIG. 14 is a sequence diagram of an example of an operation performed by the information processing system 1 according to the present embodiment when the usage rate of the parcel locker 14 exceeds the work attendance reminder notification threshold value. As indicated in step S1, the operation illustrated in the sequence diagram of FIG. 14 is executed asynchronously and periodically (e.g., once a day). When the locker management system 12 has a function of notifying that the usage rate of the parcel locker 14 exceeds the work attendance reminder notification threshold value, the processes of step S4 and the subsequent steps in FIG. 14 may be executed in response to the notification from the locker management system 12.

In step S2, the locker cooperation unit 36 acquires the usage rate of the parcel locker 14 from the locker management system 12. In step S3, the locker cooperation unit 36 compares the usage rate of the parcel locker 14 acquired in step S2 with the work attendance reminder notification threshold value included in the information of the locker linkage notification setting of FIG. 10, and checks whether the usage rate of the parcel locker 14 is equal to or greater than the work attendance reminder notification threshold value. When the usage rate of the parcel locker 14 is not equal to or greater than the work attendance reminder notification threshold value, the operation illustrated in the sequence diagram of FIG. 14 ends.

The work attendance reminder notification is sometimes a burden for the user. Accordingly, in the present embodiment, the work attendance reminder notification is sent when the usage rate of the parcel locker 14 increases and the parcel locker 14 experiences high usage. Thus, the burden on the user decreases.

When the usage rate of the parcel locker 14 is equal to or greater than the work attendance reminder notification threshold value, the operation proceeds to step S4. In step S4, the locker cooperation unit 36 acquires a locker user list of the parcel locker 14 from the locker management system 12. The locker user list of the parcel locker 14 is a list of user IDs of users who are using the parcel locker 14. The locker user list of the parcel locker 14 is created by the locker management system 12 referring to the locker usage information as illustrated in FIG. 11. The locker user list of the parcel locker 14 indicates the user ID of the recipient (locker user) for each locker ID in which a parcel is stored.

In step S5, the locker cooperation unit 36 acquires the work status of the locker user from the work status management unit 30. The work status management unit 30 reads the work status of the locker user from the work status information of FIG. 5 and provides the locker cooperation unit 36 with the read work status.

In step 6, the locker cooperation unit 36 send a work attendance reminder notification to the locker user whose work status is a state other than working at the office and prompts the locker user to pick up a parcel stored in the parcel locker 14. The work attendance reminder notification may include information indicating the position of the parcel locker 14 in which the parcel is stored.

With the operation described above with reference to the sequence diagram of FIG. 14, the information processing apparatus 10 and the locker management system 12 cooperate with each other, and thus, when the work status of the locker user is a state other than working at the office, the locker user is encouraged to come to the office. This promotes the pickup of parcels. Accordingly, the operation described above with reference to the sequence diagram of FIG. 14 prevents the time period during which a parcel is stored in the parcel locker 14 from getting longer and increases the turnover rate of the parcel locker 14.

Further, the operation described above with reference to the sequence diagram of FIG. 14 increases the turnover rate of the parcel locker 14, and thus reduces the number of compartments of the parcel locker 14 and the usage cost of the parcel locker 14.

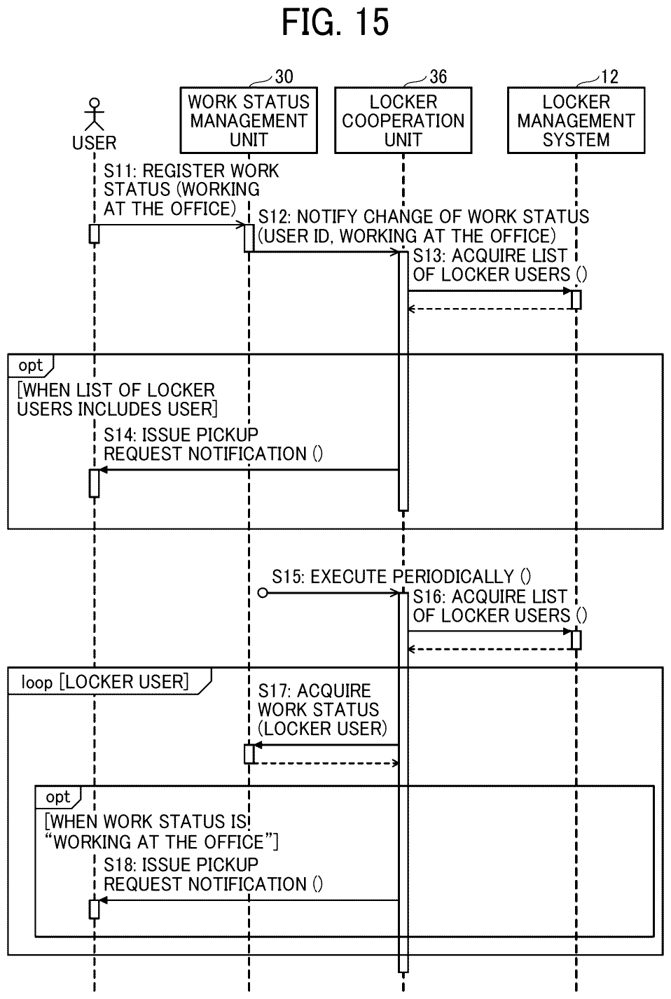

When the user updates the work status to “working at the office,” the information processing system 1 according to the present embodiment further increases the turnover rate of the parcel locker 14 by an operation as illustrated in the sequence diagram of FIG. 15.

FIG. 15 is a sequence diagram illustrating an example of an operation performed by the information processing system 1 according to the present embodiment when the user updates the work status to working at the office. In step S11, the user who uses the user terminal 18 requests the work status management unit 30 to register the work status of working at the office by operating (e.g., clicking) the button of working at the office in the work status notification field 101 on the user screen of FIG. 13. The work status management unit 30 updates the work status of the user included in the work status information of FIG. 5 to “working in the office.”

In step S12, the work status management unit 30 notifies the locker cooperation unit 36 of the work status change with designation of the user ID and the work status of working at the office. In step S13, the locker cooperation unit 36 acquires a locker user list of the parcel locker 14 from the locker management system 12. The locker user list of the parcel locker 14 is a list of user IDs of users who are using the parcel locker 14.

The locker cooperation unit 36 checks whether the user ID of the user whose work status is updated to “working at the office” is included in the acquired locker user list of the parcel locker 14. When the acquired locker user list of the parcel locker 14 includes the user ID of the user whose work status is updated to “working at the office,” the parcel of the user is stored in the parcel locker 14.

When the parcel of the user is stored in the parcel locker 14, the locker cooperation unit 36 sends a notification indicating a pickup request to the user in step S14 and prompts the user to pick up the parcel stored in the parcel locker 14.

The processes of step S15 and subsequent steps in FIG. 15 are performed periodically (e.g., several times a day such as at noon and before the regular closing time) for the user whose work status is “working at the office.” In step S16, the locker cooperation unit 36 acquires a locker user list of the parcel locker 14 from the locker management system 12. The locker user list of the parcel locker 14 is a list of user IDs of users who are using the parcel locker 14.

In step S17, the locker cooperation unit 36 acquires the work status of the locker user from the work status management unit 30. The work status management unit 30 reads the work status of the locker user from the work status information of FIG. 5 and provides the locker cooperation unit 36 with the read work status.

The locker cooperation unit 36 sends a pickup request notification to the locker user whose work status is “working at the office” in step S18, and prompts the locker user to pick up a parcel stored in the parcel locker 14. The pickup request notification may include information indicating the position of the parcel locker 14 in which the parcel is stored.

With the operation described above with reference to the sequence diagram of FIG. 15, the information processing apparatus 10 and the locker management system 12 cooperate with each other, and thus, when the locker user comes to the office, the pickup request notification, which serves as a reminder to pick up a parcel, is sent. This promotes the pickup of parcels. Further, with the operation described above with reference to the sequence diagram of FIG. 15, when the locker user has not taken out the parcel from the parcel locker 14 after the locker user comes to the office, the pickup request notification, which serves as a reminder to pick up a parcel, is sent again. This promotes the pickup of parcels.

Accordingly, the operation described above with reference to the sequence diagram of FIG. 15 prevents the time period during which a parcel is stored in the parcel locker 14 from getting longer and increases the turnover rate of the parcel locker 14.

Further, the operation described above with reference to the sequence diagram of FIG. 15 increases the turnover rate of the parcel locker 14, and thus reduces the number of compartments of the parcel locker 14 and the usage cost of the parcel locker 14.

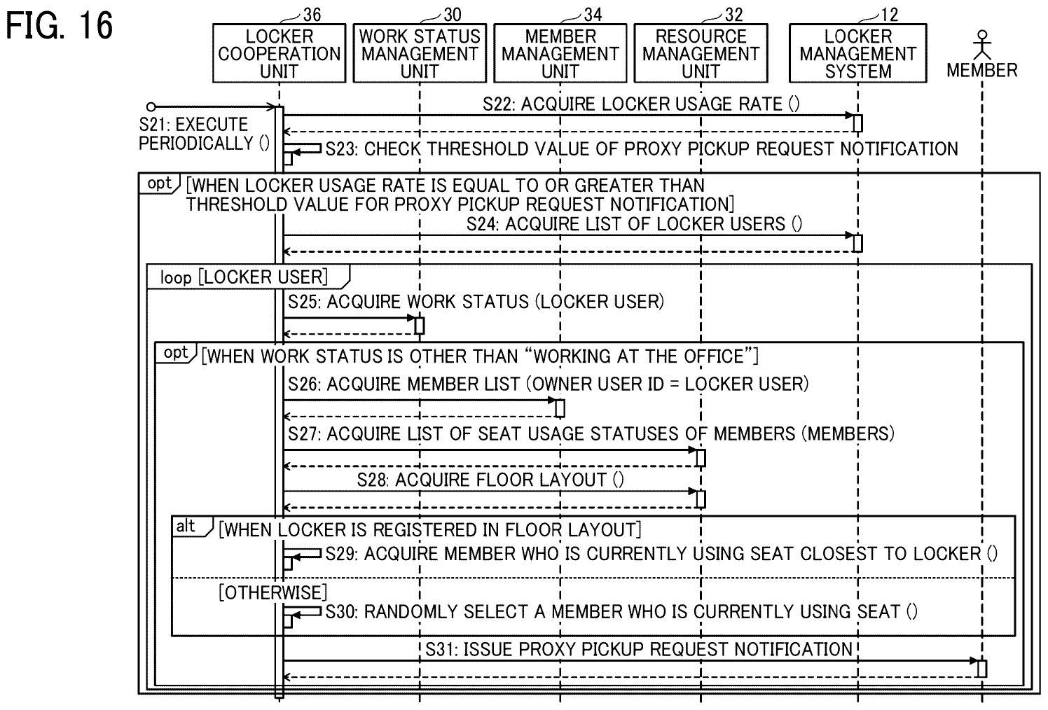

When the usage rate of the parcel locker 14 exceeds the proxy pickup request notification threshold value, the information processing system 1 according to the present embodiment further increases the turnover rate of the parcel locker 14 by an operation as illustrated in the sequence diagram of FIG. 16.

FIG. 16 is a sequence diagram of an example of an operation performed by the information processing system I according to the present embodiment when the usage rate of the parcel locker 14 exceeds the proxy pickup request notification threshold value. As indicated in step S21, the operation illustrated in the sequence diagram of FIG. 16 is executed asynchronously and periodically (e.g., once a day). When the locker management system 12 has a function of notifying that the usage rate of the parcel locker 14 exceeds the proxy pickup request notification threshold value, the processes of step S24 and the subsequent steps in FIG. 16 may be executed in response to the notification from the locker management system 12.

In step S22, the locker cooperation unit 36 acquires the usage rate of the parcel locker 14 from the locker management system 12. In step S23, the locker cooperation unit 36 compares the usage rate of the parcel locker 14 acquired in step S22 with the proxy pickup request notification threshold value included in the information of the locker linkage notification setting of FIG. 10, and checks whether the usage rate of the parcel locker 14 is equal to or greater than the proxy pickup request notification threshold value. When the usage rate of the parcel locker 14 is not equal to or greater than the proxy pickup request notification threshold value, the operation illustrated in the sequence diagram of FIG. 16 ends.

The proxy pickup request notification is sometimes a burden for the member. Accordingly, in the present embodiment, the proxy pickup request notification is sent when the usage rate of the parcel locker 14 increases and the parcel locker 14 experiences high usage. Thus, the burden on the member decreases.

When the usage rate of the parcel locker 14 is equal to or greater than the proxy pickup request notification threshold value, the operation proceeds to step S24. In step S24, the locker cooperation unit 36 acquires a locker user list of the parcel locker 14 from the locker management system 12. The locker user list of the parcel locker 14 is a list of user IDs of users who are using the parcel locker 14.

The processes of step S25 and subsequent steps are performed for each of the locker users of the parcel locker 14 acquired in step S24. In step S25, the locker cooperation unit 36 acquires the work status of the locker user from the work status management unit 30. The work status management unit 30 reads the work status of the locker user from the work status information of FIG. 5 and provides the locker cooperation unit 36 with the read work status.

As described above with reference to FIG. 15, the locker cooperation unit 36 sends the pickup request notification, which serves as a reminder to pick up a parcel, to a locker user whose work status is “working at the office,” thereby promoting the pickup of parcels.

When the work status of the locker users is a state other than working at the office, the locker cooperation unit 36 performs the processes of step S26 and the subsequent steps to select a member to whom the proxy pickup request notification is to be sent.

In step S26, the locker cooperation unit 36 acquires the member user ID list associated with the locker user (the owner user ID) from the member setting information of FIG. 9 by designating the user ID of the locker user.

In step S27, the locker cooperation unit 36 acquires a seat usage status list of the members included in the acquired member user ID list from the resource management unit 32. The seat usage status list of the members is a list of resource IDs of seats currently being used by the members. The list of the resource IDs of the seats currently being used by the members is created by the resource management unit 32 referring to the seat usage information as illustrated in FIG. 8. The list of the resource IDs of the seats currently being used by the members indicates the resource ID of the seat currently being used for each of the members.

In step S28, the locker cooperation unit 36 acquires the floor layout information from the resource management unit 32. The locker cooperation unit 36 determines whether the parcel locker 14 is registered in the floor layout by acquiring the floor layout information.

When the parcel locker 14 is registered in the floor layout, in step S29, the locker cooperation unit 36 selects a member who is using a seat closest to the position where the parcel locker 14 is located as a member to whom the proxy pickup request notification is to be sent. The locker cooperation unit 36 may preferentially select a member to whom the proxy pickup request notification is to be sent from one or more members who are using the seats near the position where the parcel locker 14 is located.

In the present embodiment, by preferentially selecting a member who is using a seat near the position where the parcel locker 14 is located, the load on the member who picks up the parcel on behalf of the user moving to the parcel locker 14 is reduced.

When the parcel locker 14 is not registered in the floor layout, in step S30, the locker cooperation unit 36 may randomly select a member to whom the proxy pickup request notification is to be sent from the members who are currently using the seats.

In step S31, the locker cooperation unit 36 sends the proxy pickup request notification to the member selected in step S29 or S30, and requests the member to pick up the parcel stored in the parcel locker 14 on behalf of the user. The proxy pickup request notification may include information indicating the position of the parcel locker 14 in which the parcel for which the proxy pickup is requested is stored.

With the operation described above with reference to the sequence diagram of FIG. 16, the information processing apparatus 10 and the locker management system 12 cooperate with each other, and thus, when the work status of the locker user is a state other than working at the office, a member who picks up the parcel on the locker user's behalf from the parcel locker 14 is requested to pick up the parcel on the locker user's behalf. This promotes the pickup of parcels. Accordingly, the operation described above with reference to the sequence diagram of FIG. 16 prevents the time period during which a parcel is stored in the parcel locker 14 from getting longer and increases the turnover rate of the parcel locker 14.

Further, the operation described above with reference to the sequence diagram of FIG. 16 increases the turnover rate of the parcel locker 14, and thus reduces the number of compartments of the parcel locker 14 and the usage cost of the parcel locker 14.

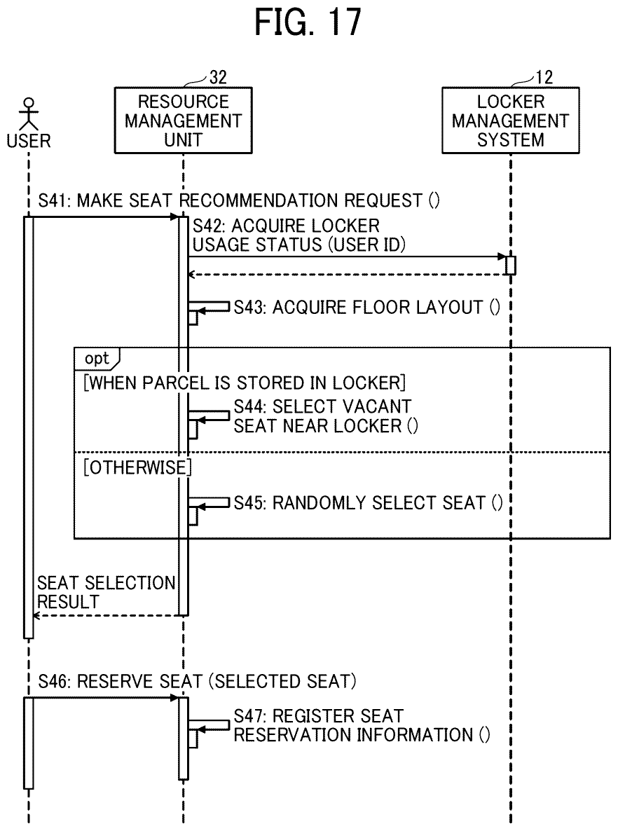

When the user uses a seat recommendation function, the information processing system 1 according to the present embodiment further increases the turnover rate of the parcel locker 14 by an operation as illustrated in the sequence diagram of FIG. 17. The seat recommendation function is a function of recommending a seat suitable for a user who has made a seat recommendation request among available seats.

FIG. 17 is a sequence diagram illustrating an example of an operation performed by the information processing system 1 according to the present embodiment when the user uses the seat recommendation function.

In step S41, a user who uses the user terminal 18 makes a seat recommendation request to the resource management unit 32. In step S42, the resource management unit 32 designates the user ID who has made the seat recommendation request and acquires the usage status of the parcel locker 14.

In step S43, the resource management unit 32 acquires the floor layout information to determine the position where the parcel locker 14 is located and the positions of available seats (empty seats).

The resource management unit 32 determines whether a parcel of which the recipient is the user who has made the seat recommendation request is present (stored) in the parcel locker 14 by referring to the usage status of the parcel locker 14 acquired in step S42.

When the parcel of which the recipient is the user who has made the seat recommendation request is present in the parcel locker 14, in step S44, the resource management unit 32 selects an empty seat near the position where the parcel locker 14 is located. In the present embodiment, by selecting an empty seat near the position where the parcel locker 14 is located, the load on the user as the recipient moving to the parcel locker 14 is reduced. When the parcel of which the recipient is the user who has made the seat recommendation request is not present in the parcel locker 14, in step S45, the resource management unit 32 randomly selects an empty seat. When there is any attribute to be used in selecting an empty seat other than the usage status of the parcel locker 14, the empty seat may be selected using such attribute.

The resource management unit 32 notifies the user who has made the seat recommendation request of the empty seat selected in step S44 or S45 as a seat selection result. The resource management unit 32 also includes in the seat selection result a reason for the seat selection that the parcel is stored in the parcel locker 14. Further, the seat selection result may include information indicating the position of the parcel locker 14 in which the parcel is stored.

When the seat selection is performed because the parcel is stored in the parcel locker 14, the user who has made the seat recommendation request can recognize why that seat is selected. Accordingly, when a parcel is stored in the parcel locker 14, the user who has made the seat recommendation request is prompted to pick up the stored parcel.

When the user checks the seat selection result and finds no problem, in step S46, the user reserves the seat according to the seat selection result. In step S47, the resource management unit 32 receives the seat reservation from the user and registers the seat reservation as seat reservation information.

With the operation described above with reference to the sequence diagram of FIG. 17, the information processing apparatus 10 and the locker management system 12 cooperate with each other, and thus, when the makes the seat recommendation request, notifies the user of the seat selection result including the reason why the seat is selected, which serves as a reminder to pick up a parcel. This promotes the pickup of parcels.

Accordingly, the operation described above with reference to the sequence diagram of FIG. 17 prevents the time period during which a parcel is stored in the parcel locker 14 from getting longer and increases the turnover rate of the parcel locker 14.

Further, the operation described above with reference to the sequence diagram of FIG. 17 increases the turnover rate of the parcel locker 14, and thus reduces the number of compartments of the parcel locker 14 and the usage cost of the parcel locker 14.

In the present embodiment, although a description given above is of an example of the parcel locker 14 located, for example, in an office where a user comes to work, the present embodiment is not limited to the parcel locker 14 located in the office or the like. The present embodiment can be applied to the parcel locker 14 located in shops, stations, facilities, etc., near the office or the like, provided that the parcel locker 14 is managed by the locker management system 12 that can cooperate with the information processing apparatus 10.

### Second Embodiment:

A second embodiment relates to an example in which the parcel locker 14 is located in a university. The university is just an example. The second embodiment is applicable to, for example, a vocational school, a high school, and a training facility. The second embodiment is described with reference to some of the drawings of the first embodiment, and the redundant description are omitted as below.

### System Configuration

The administrator terminal 16 is a communication terminal used by an administrator of a university. The user terminal 18 is a communication terminal used by a user (e.g., a student) who attends a university. The user who attends a university is an example of a user who is in an attendance status, either being present or a state other than being present. The information processing apparatus 10 manages the attendance status of a user who uses the user terminal 18. The information processing apparatus 10 further manages layout information of resources including a place (attendance place) where the user who uses the user terminal 18 attends and the parcel locker 14. The attendance place may be in units of university campuses, buildings, or classrooms.

The information processing apparatus 10 acquires information on a user who is a recipient of a parcel stored in the parcel locker 14 from the locker management system 12, and performs processing according to the attendance status of the user who is the recipient. This prevents the time period during which the parcel is stored in the parcel locker 14 from getting longer and increases the turnover rate of the parcel locker 14.

### Functional Configuration

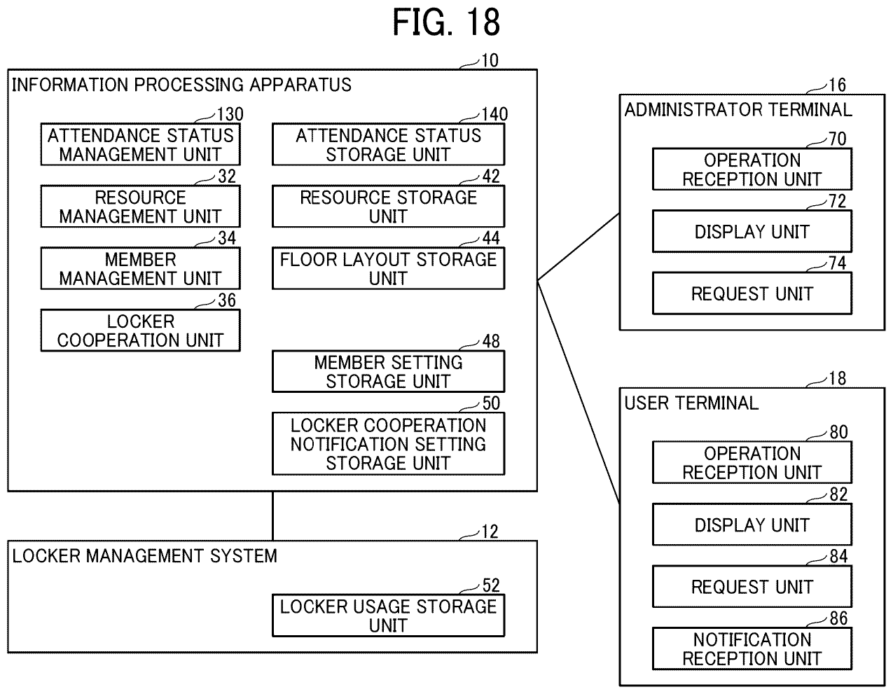

FIG. 18 is a block diagram illustrating an example of the functional configuration of the information processing system I according to the present embodiment. The functional configuration illustrated in FIG. 18 is different in a part from the functional configuration illustrated in FIG. 4. In the functional configuration illustrated in FIG. 18, the work status management unit 30 in FIG. 4 is replaced with an attendance status management unit 130. Further, in the functional configuration illustrated in FIG. 18, the work status storage unit 40 in FIG. 4 is replaced with an attendance status storage unit 140. Although the seat usage storage unit 46 is omitted in the functional configuration illustrated FIG. 18, the functional configuration may include the seat usage storage unit 46. The attendance status management unit 130 illustrated in FIG. 18 is implemented by, for example, the smartphone 400 illustrated in FIG. 2 or the computer 500 illustrated in FIG. 3 executing an OS and a program.

The attendance status management unit 130 manages an attendance status of a user who attends a university. The attendance status of the user includes, for example, being present, being absent, and class canceled. The being absent or the class canceled is an example of the attendance status of the user other than the being present. When the attendance status of the user changes, the attendance status management unit 130 notifies the locker cooperation unit 36 of the attendance status change. The attendance status management unit 130 sends the attendance status of the user in response to a request from the locker cooperation unit 36.

The resource management unit 32 manages layout information of resources including multiple attendance places where the user attends and the parcel locker 14. The resource management unit 32 manages the attendance status of the user who attends to the university for the attendance places.

When the resource management unit 32 receives a reservation for attendance from a user who attends a university, the resource management unit 32 checks with the locker cooperation unit 36 whether a parcel of which the recipient is the user is stored. When a parcel of which the recipient is the user from whom the reservation for attendance is received is stored in the parcel locker 14, the resource management unit 32 issues a notification to prompt the user to pick up the parcel stored in the parcel locker 14. In the present embodiment, issuing the notification that prompts the pickup of the parcel stored in the parcel locker 14 prevents the time period during which a parcel of which the recipient is a user other than a user whose attendance status is being present from getting longer and increases the turnover rate of the parcel locker 14.

The member management unit 34 manages members who pick up a parcel from the parcel locker 14 on behalf of the user as a recipient of the parcel. The member management unit 34 manages the settings of members registered for respective users. The member management unit 34 sends the settings of members registered for respective users in response to a request from the locker cooperation unit 36. For the user who attends a university, the members include, for example, a friend, a colleague who belongs to the same seminar or club, etc.

The locker cooperation unit 36 cooperates with the locker management system 12 that manages the usage status of the parcel locker 14, and checks whether a parcel of which recipient is the user is stored in the parcel locker 14. When the parcel locker 14 stores a parcel of which the recipient is the user, the locker cooperation unit 36 issues the notification. This prevents the time period during which a parcel of which the recipient is a user other than a user whose attendance state is being present among parcels stored in the parcel locker 14 from getting longer and increases the turnover rate of the parcel locker 14.

The locker cooperation unit 36 receives a check as to whether a parcel of which the recipient is the user is stored from the resource management unit 32. When a parcel of which the recipient is the user is stored in the parcel locker 14, the locker cooperation unit 36 send a reply indicating that the parcel is stored.

The locker cooperation unit 36 acquires the attendance status of the user who is the recipient of a parcel stored in the parcel locker 14 from the attendance status management unit 130. The locker cooperation unit 36 acquires, from the member management unit 34, the settings of members who receive a parcel from the parcel locker 14 on behalf of the user who is the recipient of the parcel.

The attendance status storage unit 140 stores attendance status information of a user. Information of a locker cooperation notification setting stored in the locker cooperation notification setting storage unit 50 includes an attendance reminder notification threshold value and a proxy pickup request notification threshold value as attributes. The attendance reminder notification threshold value is a threshold value of the locker usage rate for determining whether to issue a reminder to attend, for example, a university. In the disclosure, such a reminder may be referred to as an “attendance reminder notification.” The proxy pickup request notification threshold value is a threshold of the locker usage rate for determining whether to issue a proxy pickup request notification. The operation reception unit 80 of the user terminal 18 receives various operations from the user or a member who pick up a parcel from the parcel locker 14 on behalf of the user.

### UI Example

An administrator who uses the administrator terminal 16 sets the attendance reminder notification threshold value and the proxy pickup request notification threshold value included in the information of the locker cooperation notification setting, for example, via an administrator setting screen. According to the settings of the attendance reminder notification threshold value and the proxy pickup request notification threshold value configured by the administrator on the administrator setting screen, the information processing system 1 according to the present embodiment issues the attendance reminder notification when the locker usage rate reaches 80%, and issues the proxy pickup request notification when the locker usage rate reaches 90%.

The user who uses the user terminal 18 updates the attendance status of the user included in the attendance status information by operating (e.g.,) the buttons of being present and being absent on a user screen. The user who uses the user terminal 18 may register or deregister a member from a member edit link. The user screen may display the current attendance status of the user who has logged in and the current attendance status of the members. The attendance status included in the attendance status information may be updated in cooperation with an attendance management system using a card reader that reads an integrated circuit (IC) card.

### Operation

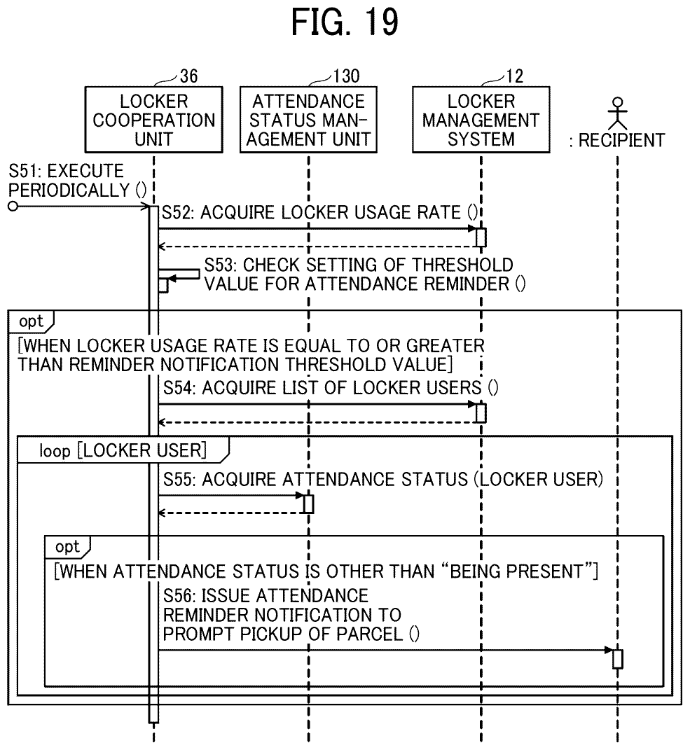

When the usage rate of the parcel locker 14 exceeds the attendance reminder notification threshold value, the information processing system 1 according to the present embodiment performs an operation illustrated in the sequence diagram of FIG. 19. Thus, the usage rate of the parcel locker 14 increases.

FIG. 19 is a sequence diagram of an example of an operation performed by the information processing system 1 according to the present embodiment when the usage rate of the parcel locker 14 exceeds the attendance reminder notification threshold value. The operation illustrated in the sequence diagram of FIG. 19 is executed asynchronously and periodically. When the locker management system 12 has a function of notifying that the usage rate of the parcel locker 14 exceeds the attendance reminder notification threshold value, the processes of step S54 and the subsequent steps in FIG. 19 may be executed in response to the notification from the locker management system 12.

In step S52, the locker cooperation unit 36 acquires the usage rate of the parcel locker 14. In step S53, the locker cooperation unit 36 compares the usage rate of the parcel locker 14 with the attendance reminder notification threshold value, and checks whether the usage rate of the parcel locker 14 is equal to or greater than the attendance reminder notification threshold value. When the usage rate of the parcel locker 14 is not equal to or greater than the attendance reminder notification threshold value, the operation illustrated in the sequence diagram of FIG. 19 ends.

The attendance reminder notification is sometimes a burden for the user. Accordingly, in the present embodiment, the attendance reminder notification is sent when the usage rate of the parcel locker 14 increases and the parcel locker 14 experiences high usage. Thus, the burden on the user decreases.

When the usage rate of the parcel locker 14 is equal to or greater than the attendance reminder notification threshold value, the operation proceeds to step S54. In step S54, the locker cooperation unit 36 acquires a locker user list of the parcel locker 14 from the locker management system 12.

In step S55, the locker cooperation unit 36 acquires the attendance status of the locker user from the attendance status management unit 130. The attendance status management unit 130 reads the attendance status of the locker user from the attendance status information and provides the locker cooperation unit 36 with the read attendance status.

In step 56, the locker cooperation unit 36 issues an attendance reminder notification to the locker user whose attendance status is a state other than being present and prompts the locker user to pick up a parcel stored in the parcel locker 14. The attendance reminder notification may include information indicating the position of the parcel locker 14 in which the parcel is stored.

With the operation described above with reference to the sequence diagram of FIG. 19, the information processing apparatus 10 and the locker management system 12 cooperate with each other, and thus, when the attendance status of the locker user is a state other than working being present, the locker user is encouraged to attend. This promotes the pickup of parcels. Accordingly, the operation described above with reference to the sequence diagram of FIG. 19 prevents the time period during which a parcel is stored in the parcel locker 14 from getting longer and increases the turnover rate of the parcel locker 14.

Further, the operation described above with reference to the sequence diagram of FIG. 19 increases the turnover rate of the parcel locker 14, and thus reduces the number of compartments of the parcel locker 14 and the usage cost of the parcel locker 14.

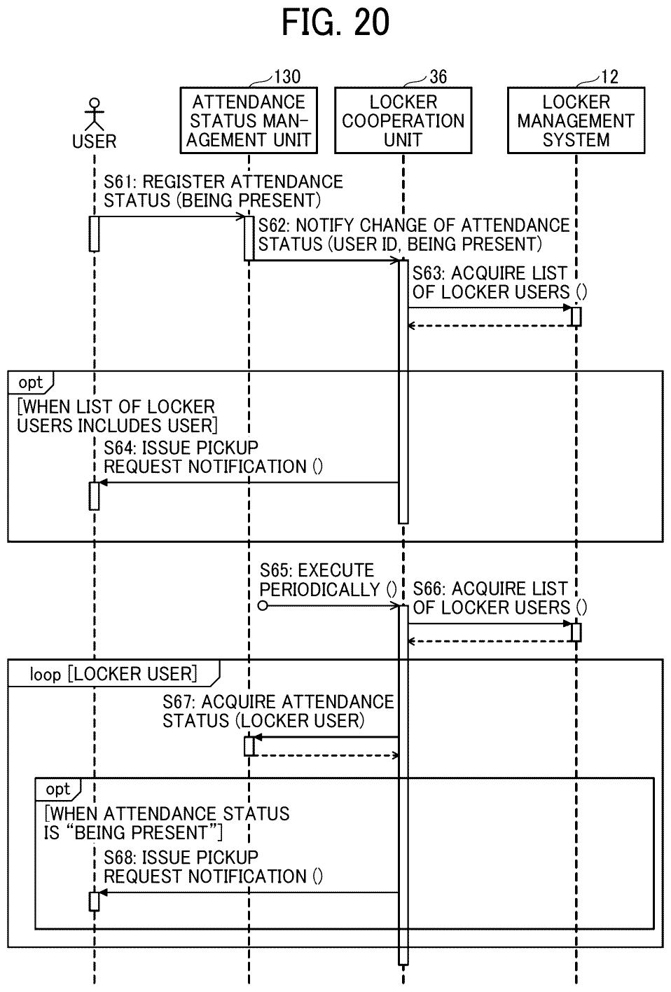

When the user updates the attendance status to “being present,” the information processing system 1 according to the present embodiment further increases the turnover rate of the parcel locker 14 by an operation as illustrated in the sequence diagram of FIG. 20.

FIG. 20 is a sequence diagram illustrating an example of an operation performed by the information processing system I according to the present embodiment when the user updates the attendance status to being present. In step S61, the user who uses the user terminal 18 requests the attendance status management unit 130 to register the attendance status of being present by operating the button for being present on the user screen. The attendance status management unit 130 updates the attendance status of the user included in the attendance status information to “being present.”

In step S62, the attendance status management unit 130 notifies the locker cooperation unit 36 of the attendance status change with designation of the user ID and the attendance status of being present. In step S63, the locker cooperation unit 36 acquires a locker user list of the parcel locker 14 from the locker management system 12.

The locker cooperation unit 36 checks whether the user ID of the user whose attendance status is updated to “being present” is included in the acquired locker user list of the parcel locker 14. When the acquired locker user list of the parcel locker 14 includes the user ID of the user whose attendance status is updated to “being present,” the parcel of the user is stored in the parcel locker 14.

When the parcel of the user is stored in the parcel locker 14, the locker cooperation unit 36 sends a notification indicating a pickup request to the user in step S64 and prompts the user to pick up the parcel stored in the parcel locker 14. A user who attends a university may attend a lecture in different classrooms in a campus for different lectures. The process of step S64 may be performed during a time period when the user is in a classroom closest to the parcel locker 14 in which the parcel is stored among classrooms in which the user attends a lecture.

The processes of step S65 and subsequent steps in FIG. 20 are performed periodically (e.g., during lunch break and after a lecture) for the user whose attendance status is “being present.” In step S66, the locker cooperation unit 36 acquires a locker user list of the parcel locker 14 from the locker management system 12.

In step S67, the locker cooperation unit 36 acquires the attendance status of the locker user from the attendance status management unit 130. The attendance status management unit 130 reads the attendance status of the locker user from the attendance status information and provides the locker cooperation unit 36 with the read attendance status.

The locker cooperation unit 36 sends a pickup request notification to the locker user whose attendance status is “being present” in step S68, and prompts the locker user to pick up a parcel stored in the parcel locker 14. The pickup request notification may include information indicating the position of the parcel locker 14 in which the parcel is stored. The process of step S68 may be performed during a time period when the user is in a classroom closest to the parcel locker 14 in which the parcel is stored among classrooms in which the user attends a lecture.

With the operation described above with reference to the sequence diagram of FIG. 20, the information processing apparatus 10 and the locker management system 12 cooperate with each other, and thus, when the locker user is present, for example, at a lecture, the pickup request notification, which serves as a reminder to pick up a parcel, is sent. This promotes the pickup of parcels. Further, with the operation described above with reference to the sequence diagram of FIG. 20, when the locker user has not taken out the parcel from the parcel locker 14 after the locker user arrives at a university, the pickup request notification, which serves as a reminder to pick up a parcel, is sent again. This promotes the pickup of parcels.

Accordingly, the operation described above with reference to the sequence diagram of FIG. 20 prevents the time period during which a parcel is stored in the parcel locker 14 from getting longer and increases the turnover rate of the parcel locker 14.

Further, the operation described above with reference to the sequence diagram of FIG. 20 increases the turnover rate of the parcel locker 14, and thus reduces the number of compartments of the parcel locker 14 and the usage cost of the parcel locker 14.

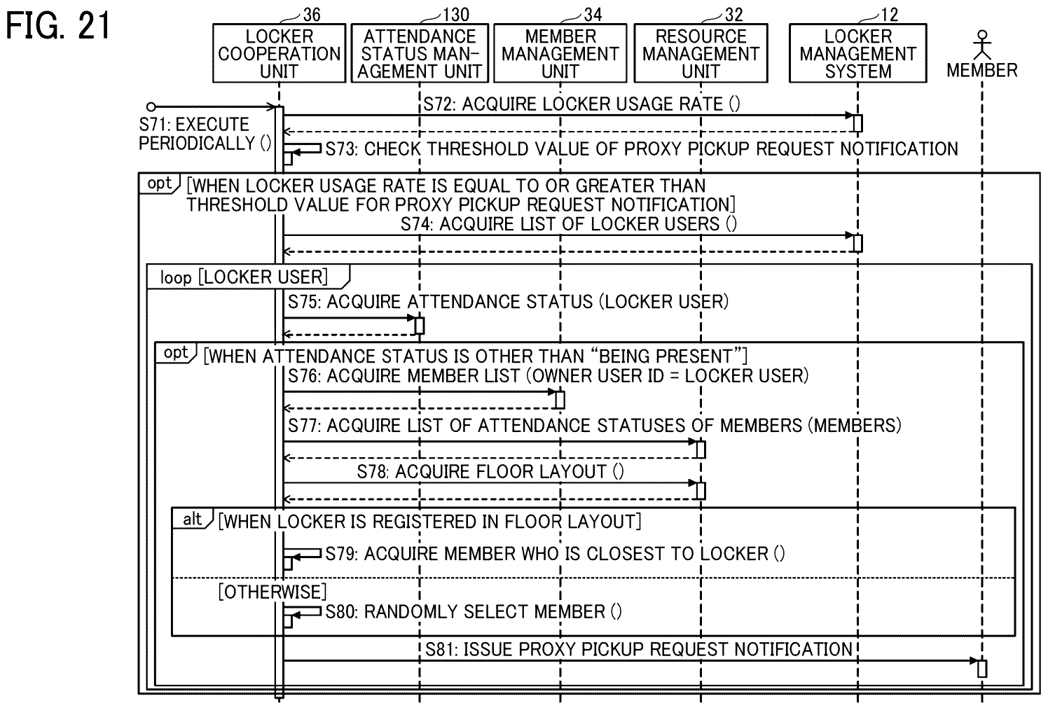

When the usage rate of the parcel locker 14 exceeds the proxy pickup request notification threshold value, the information processing system 1 according to the present embodiment further increases the turnover rate of the parcel locker 14 by an operation as illustrated in the sequence diagram of FIG. 21.

FIG. 21 is a sequence diagram of an example of an operation performed by the information processing system 1 according to the present embodiment when the usage rate of the parcel locker 14 exceeds the proxy pickup request notification threshold value. As indicated in step S71, the operation illustrated in the sequence diagram of FIG. 21 is executed asynchronously and periodically.

When the locker management system 12 has a function of notifying that the usage rate of the parcel locker 14 exceeds the proxy pickup request notification threshold value, the processes of step S74 and the subsequent steps in FIG. 21 may be executed in response to the notification from the locker management system 12.

In step S72, the locker cooperation unit 36 acquires the usage rate of the parcel locker 14 from the locker management system 12. In step S73, the locker cooperation unit 36 compares the usage rate of the parcel locker 14 with the proxy pickup request notification threshold value included in the information of the locker linkage notification setting, and checks whether the usage rate of the parcel locker 14 is equal to or greater than the proxy pickup request notification threshold value. When the usage rate of the parcel locker 14 is not equal to or greater than the proxy pickup request notification threshold value, the operation illustrated in the sequence diagram of FIG. 21 ends.

The proxy pickup request notification is sometimes a burden for the member. Accordingly, in the present embodiment, the proxy pickup request notification is sent when the usage rate of the parcel locker 14 increases and the parcel locker 14 experiences high usage. Thus, the burden on the member decreases.

When the usage rate of the parcel locker 14 is equal to or greater than the proxy pickup request notification threshold value, the operation proceeds to step S74. In step S74, the locker cooperation unit 36 acquires a locker user list of the parcel locker 14 from the locker management system 12.

The processes of step S75 and subsequent steps are performed for each of the locker users of the parcel locker 14 acquired in step S74. In step S75, the locker cooperation unit 36 acquires the attendance status of the locker user from the attendance status management unit 130. The attendance status management unit 130 reads the attendance status of the locker user from the attendance status information and provides the locker cooperation unit 36 with the read attendance status.

The locker cooperation unit 36 sends the pickup request notification, which serves as a reminder to pick up a parcel, to a locker user whose attendance status is “being present,” thereby promoting the pickup of parcels.

When the attendance status of the locker users is a state other than being present, the locker cooperation unit 36 performs the processes of step S76 and the subsequent steps to select a member to whom the proxy pickup request notification is to be sent.

In step S76, the locker cooperation unit 36 acquires the member user ID list associated with the locker user from the member setting information by designating the user ID of the locker user.

In step S77, the locker cooperation unit 36 acquires an attendance status list of the members included in the acquired member user ID list from the resource management unit 32.

In step S78, the locker cooperation unit 36 acquires the floor layout information from the resource management unit 32. The locker cooperation unit 36 determines whether the parcel locker 14 is registered in the floor layout by acquiring the floor layout information.

When the parcel locker 14 is registered in the floor layout, in step S79, the locker cooperation unit 36 selects a member who is at a position closest to the position where the parcel locker 14 is located as a member to whom the proxy pickup request notification is to be sent. The locker cooperation unit 36 may preferentially select a member to whom the proxy pickup request notification is to be sent from one or more members who are at positions near the position where the parcel locker 14 is located.

In the present embodiment, by preferentially selecting a member who is at a position near the position where the parcel locker 14 is located, the load on the member who picks up the parcel on behalf of the user moving to the parcel locker 14 is reduced.

When the parcel locker 14 is not registered in the floor layout, in step S80, the locker cooperation unit 36 may randomly select a member to whom the proxy pickup request notification is to be sent from the members who are currently attending the university.

In step S81, the locker cooperation unit 36 sends the proxy pickup request notification to the member selected in step S79 or S80, and requests the member to pick up the parcel stored in the parcel locker 14 on behalf of the locker user. The proxy pickup request notification may include information indicating the position of the parcel locker 14 in which the parcel for which the proxy pickup is requested is stored.

With the operation described above with reference to the sequence diagram of FIG. 21, the information processing apparatus 10 and the locker management system 12 cooperate with each other, and thus, when the attendance status of the locker user is a state other than being present, a member who picks up the parcel on the locker user's behalf from the parcel locker 14 is requested to pick up the parcel on the locker user's behalf. This promotes the pickup of parcels. Accordingly, the operation described above with reference to the sequence diagram of FIG. 21 prevents the time period during which a parcel is stored in the parcel locker 14 from getting longer and increases the turnover rate of the parcel locker 14.

Further, the operation described above with reference to the sequence diagram of FIG. 21 increases the turnover rate of the parcel locker 14, and thus reduces the number of compartments of the parcel locker 14 and the usage cost of the parcel locker 14.

### Third Embodiment

The first embodiment relates to an example in which the parcel locker 14 is located in an office or the like. The second embodiment relates to an example in which the parcel locker 14 is located in a university or the like. The office or the like in the first embodiment and the university or the like in the second embodiment are examples of a specific place where the parcel locker is present and a user goes repeatedly. The work status and the attendance status of the user are examples of location information of the user.

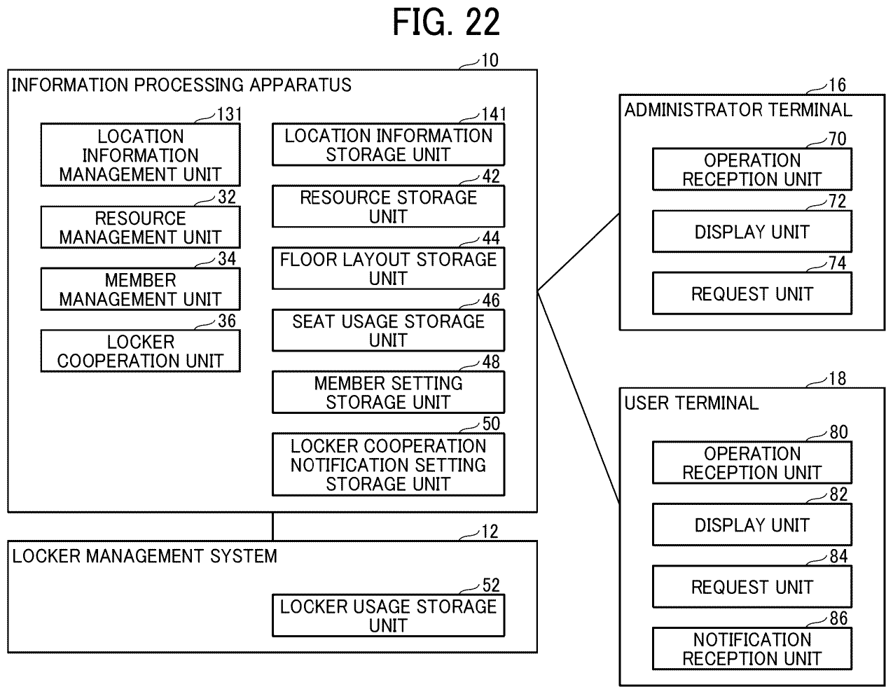

The information processing apparatus 10 according to the present embodiment may be implemented by a functional configuration as illustrated in FIG. 22. FIG. 22 is a block diagram illustrating an example of the functional configuration of the information processing system 1 according to the present embodiment.

The functional configuration illustrated in FIG. 22 is different in a part from the functional configuration illustrated in FIG. 4. In the functional configuration illustrated in FIG. 22, the work status management unit 30 in FIG. 4 is replaced with a location information management unit 131. Further, in the functional configuration illustrated in FIG. 22, the work status storage unit 40 in FIG. 4 is replaced with location information storage unit 141.

The location information management unit 131 illustrated in FIG. 22 is implemented by, for example, the smartphone 400 illustrated in FIG. 2 or the computer 500 illustrated in FIG. 3 executing an OS and a program.

The location information management unit 131 manages location information of a user who goes to the specific place where the parcel locker is present repeatedly. The location information of the user is information based on which it is determined whether the user is present at the specific place to which the user goes repeatedly. When the location information of the user changes, the location information management unit 131 notifies the locker cooperation unit 36 of the information change.

The location information management unit 131 sends the location information of the user in response to a request from the locker cooperation unit 36.

The resource management unit 32 manages layout information of resources including the specific place to which the user goes repeatedly and the parcel locker 14. The resource management unit 32 checks with the locker cooperation unit 36 whether a parcel of which the recipient is the user who has the specific place to go repeatedly to is stored. When the parcel of which the recipient is the user who has the specific place to go to repeatedly is stored in the parcel locker 14, the resource management unit 32 issues a notification prompting the user to go to the place to go to. According to the present embodiment, issuing the notification that prompts to go to the specific place to go to repeatedly prompts the pickup of the parcel stored in the parcel locker 14 that is located in the specific place to go to repeatedly or near the specific place to go to repeatedly. This prevents the time period during which a parcel of which the recipient is the user from getting longer and increases the turnover rate of the parcel locker 14.

The contents described in the first embodiment or the second embodiment may be applied to the information processing apparatus 10 according to the third embodiment. For example, in the third embodiment, an operation may be performed by replacing the work status and the working at the office in the sequence diagrams of the first embodiment. Further, in the third embodiment, an operation may be performed by replacing the attendance status and the being present in the sequence diagrams of the second embodiment.

In one aspect, a non-transitory recording medium is provided, which, when executed by one or more processors, cause the one or more processors to perform a method. The method includes: managing location information of a user who has a place to go repeatedly; acquiring information of the user who is a recipient of a parcel stored in a locker from a locker management system that manages a usage status of the locker; acquiring the location information of the user who is the recipient; and issuing a notification that prompts the user who is the recipient to go to the place to go to repeatedly when the location information indicates that the user who is the recipient is not at the place to go to repeatedly.

Currently, hybrid work, a working style that combines working in an office or the like with working from home or the like, has become popular. In the hybrid work environment, the number of days that users go to the office and the like may decrease. Lockers used by users working in the hybrid work environment may experience delays in users collecting their parcels. As a result, the parcel wait time sometimes gets longer, and the turnover rate decreases. Lockers may also be used in facilities such as universities. Lockers used by users attending facilities such as universities can sometimes have their parcel left unreceived for long periods of time if users are slow to collect their parcels, resulting in a lower turnover rate. Such a drawback may occur not only in facilities such as offices and universities but also in any places where lockers are installed.

According to an embodiment of the present disclosure, the turnover rate of lockers in which a user's parcel is stored increases.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in the above-described embodiments are merely one example of multiple computing environments that implement the embodiments disclosed herein. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus, comprising circuitry configured to:
manage location information indicating a current location of a user who goes to a specific place where a locker is present repeatedly;
acquire information of the user who is a recipient of a parcel stored in the locker from a locker management system that manages a usage status of the locker;
acquire the location information of the user who is the recipient; and
issue a notification that prompts the user who is the recipient to go to the specific place when the location information indicates that the user who is the recipient is not at the specific place.

2. The information processing apparatus according to claim 1, wherein
the location information further indicates a work status of the user,
the specific place is a place where the user goes to work,
the information of the user who is the recipient includes the work status of the user, and
the notification prompts the user to go to the place where the user goes to work, when the work status of the user who is the recipient is a status other than the status of working at the place where the user goes to work.

3. The information processing apparatus according to claim 2, wherein
the circuitry determines whether the locker stores a parcel of which a recipient is the user whose work status has been updated to the working at the place where the user goes to work, and issues the notification prompting the user to pick up the parcel when a determination result indicates that the locker stores the parcel of which the recipient is the user.

4. The information processing apparatus according to claim 2, wherein
the circuitry periodically determines whether the locker stores a parcel of which a recipient is the user whose work status is the working at the place where the user goes to work, and issues the notification prompting the user to pick up the parcel when a determination result indicates that the locker stores the parcel of which the recipient is the user.

5. The information processing apparatus according to claim 2, wherein the circuitry is further configured to:
manage information on a member who picks up the parcel on behalf of the user; and
issue another notification requesting the member to pick up the parcel on behalf of the user when the work status of the user who is a recipient of the parcel is a status other than the working at the place where the user goes to work.

6. The information processing apparatus according to claim 5, wherein the circuitry is further configured to:
manage layout information of resources including seats and the locker that are located in the place where the user goes to work and usage statuses of the resources;
select a member who is using a seat near the locker storing the parcel of which the recipient is the user whose work status is the status other than the working at the place where the user goes to work from among the seats; and
issue the notification requesting the selected member to pick up the parcel on behalf of the user.

7. The information processing apparatus according to claim 2, wherein
the circuitry is further configured to:
manage layout information of resources including seats and the locker that are located in the place where the user goes to work and usage statuses of the resources;
receives from the user a seat reservation for a seat among the seats;
select a particular seat near the locker storing the parcel of which the recipient is the user who has sent the seat reservation;
issue another notification recommending the selected particular seat to the user; and
issue the notification prompting the user to pick up the parcel.

8. The information processing apparatus according to claim 2, wherein
the circuitry issues the notification prompting the user who is the recipient of the parcel to come to the place where the user goes to work, when a usage rate of the locker exceeds a threshold value.

9. The information processing apparatus according to claim 5, wherein
the circuitry issues the notification requesting the member to pick up the parcel on behalf of the user when a usage rate of the locker exceeds a threshold value.

10. The information processing apparatus according to claim 1, wherein
the location information further indicates an attendance status of the user,
the information of the user who is the recipient includes the attendance status of the user, and the notification prompts the user to attend, when the attendance status of the user who is the recipient is a status other than the status of being present.

11. The information processing apparatus according to claim 10, wherein
the circuitry determines whether the locker stores the parcel of which the recipient is the user whose attendance status has been updated to the status of being present, and issues the notification prompting the user to pick up the parcel when a determination result indicates that the locker stores the parcel of which the recipient is the user.

12. The information processing apparatus according to claim 10, wherein
the circuitry periodically determines whether the locker stores the parcel of which the recipient is the user whose attendance status is the status of being present, and issues the notification prompting the user to pick up the parcel when a determination result indicates that the locker stores the parcel of which the recipient is the user.

13. The information processing apparatus according to claim 10, wherein the circuitry is further configured to:
manage a member who picks up the parcel on behalf of the user; and
issue another notification requesting the member to pick up the parcel on behalf of the user when the attendance status of the user who is the recipient of the parcel is a status other than the status of being present.

14. The information processing apparatus according to claim 10, wherein the circuitry is further configured to:
manage layout information of resources including a plurality of attendance places where the user attends and the locker;
select a particular attendance place from the plurality of attendance places, the particular attendance place being near the locker storing the parcel of which the recipient is the user; and
issue the notification requesting the user who is in the selected particular attendance place to pick up the parcel.

15. The information processing apparatus of claim 10, wherein
the circuitry issues the notification prompting the user who is the recipient of the parcel to attend when a usage rate of the locker exceeds a threshold value.

16. The information processing apparatus according to claim 13, wherein
the circuitry issues the other notification requesting the member to pick up the parcel on behalf of the user when a usage rate of the locker exceeds a threshold value.

17. An information processing system, comprising:
a user terminal; and
an information processing apparatus communicably connected to the user terminal,
the information processing apparatus including first circuitry configured to:
manage location information indicating a current location of a user who goes to a specific place where a locker is present repeatedly;
acquire information of the user who is a recipient of a parcel stored in the locker from a locker management system that manages a usage status of the locker;
acquire the location information of the user who is the recipient; and
issue a notification that prompts the user who is the recipient to go to the specific place when the location information indicates that the user who is the recipient is not at the specific place,
the user terminal including second circuitry configured to:
receive the notification from the information processing apparatus; and
display the notification.

18. An information processing method performed by an information processing apparatus, the information processing method comprising:
managing location information indicating a current location of a user who goes to a specific place where a locker is present repeatedly;
acquiring information of the user who is a recipient of a parcel stored in the locker from a locker management system that manages a usage status of the locker;
acquiring the location information of the user who is the recipient; and
issuing a notification that prompts the user who is the recipient to go to the specific place when the location information indicates that the user who is the recipient is not at the specific place.
